(19) United States
(12) Patent Application Publication
(10) Pub. No.: US 2025/0354226 A1
(43) Pub. Date: Nov. 20, 2025

(54) METHOD AND AN ARRANGEMENT FOR A CONTINUOUS PRODUCTION OF SPONGE IRON FROM IRON ORE

(71) Applicant: HYBRIT Development AB, Stockholm (SE)

(72) Inventor: Gunilla Hyllander, Södra Sunderbyn (SE)

(21) Appl. No.: 18/867,332

(22) PCT Filed: May 25, 2023
(86) PCT No.: PCT/SE2023/050513

§ 371 Date: Nov. 19, 2024

(30) Foreign Application Priority Data
May 25, 2022 (SE) 2250624-0

(51) Int. Cl. C21B 13/00; C21B 13/02

(52) U.S. Cl. CPC C21B 13/004; C21B 13/0073; C21B 13/02

(57) ABSTRACT

An arrangement for producing sponge iron, including a direct reduction shaft, a device for charging iron ore into the direct reduction shaft, a device for extracting sponge iron from the direction reduction shaft, a hydrogen-rich reduction gas source, a reduction gas line extending from the hydrogen-rich reduction gas source to the direct reduction shaft, and a heater for heating the hydrogen-rich reduction gas in the reduction gas line. The arrangement further includes a flow rate meter configured to measure the flow rate of the hydrogen-rich reduction gas in the reduction gas line, and a control unit configured to control the device for charging iron ore into the direct reduction shaft and to control the device for extracting sponge iron from the direct reduction shaft based on input from the flow rate meter, such that the flow rate of the iron ore and the flow rate of the sponge iron are proportional to the measured flow rate of the hydrogen-rich reduction gas.

### TECHNICAL FIELD

The present invention relates to continuous production of sponge iron from iron ore, comprising the steps of: charging iron ore into a direct reduction shaft; providing a hydrogen-rich reduction gas; heating the hydrogen-rich reduction gas to a predetermined temperature; introducing the heated hydrogen-rich reduction gas into the direct reduction shaft in order to reduce the iron ore and produce sponge iron, and extracting the produced sponge iron from the direct reduction shaft.

The invention also relates to an arrangement for producing sponge iron, comprising: a direct reduction shaft; a device for charging iron ore into the direct reduction shaft; a device for extracting sponge iron from the direction reduction shaft; a hydrogen-rich reduction gas source; a reduction gas line extending from the device for providing the hydrogen-rich reduction gas to the direction reduction shaft; and a heater for heating the hydrogen-rich reduction gas.

### BACKGROUND

Continuous production of sponge iron by means of direct reduction of iron ore in a direct reduction shaft is known. Thereby, hydrogen may primarily be used as the reduction gas, whereby carbon dioxide emissions from the shaft are considerably reduced in comparison to technology that primarily uses carbon-containing gas, such as natural gas, as the reduction gas.

Hydrogen gas is typically produced in so called electrolysers, through a process driven by electricity. The access to the electric power needed for the electrolysers may vary over time and/or the price of the available electric power may fluctuate. As a result thereof, the flow rate from the electrolysers to the direct reduction shaft may fluctuate. Prior art suggests addition of further reduction gas, such as natural gas, to the flow of hydrogen gas in order to compensate for the fluctuations of the latter. However, such compensation results in an increased emission of carbon dioxide emission.

### THE OBJECT OF THE INVENTION

It is an object of the invention to present a method of and an arrangement for producing sponge iron by direct reduction of iron ore by means of a hydrogen-rich reduction gas, which method and arrangement compensate for fluctuations of the flow rate of the hydrogen-rich reduction gas with a reduced emission of carbon dioxide from the direct reduction in comparison to solution in which natural gas is used for compensation or with no increase at all of the emission of carbon dioxide.

The fluctuations of the flow rate of the hydrogen-rich gas may be due to deliberate control of the flow rate, for example caused by fluctuations of prize of electric power needed for production of hydrogen used in the process, or non-deliberate fluctuations, for example caused by fluctuating availability of electric power used for generating the hydrogen used in the method. In the cases when hydrogen gas is taken from a top gas from the direct reduction shaft and added to the hydrogen gas used as reduction gas, the fluctuations may also be caused by fluctuating conditions in the direct reduction shaft resulting in fluctuations of the flow rate of hydrogen gas taken from the top gas. The fluctuations may be of substantial degree and may have a duration of considerable time.

### SUMMARY

The object of the invention is achieved by means of a method for a continuous production of sponge iron from iron ore, comprising the steps of:
charging iron ore into a direct reduction shaft;
providing a hydrogen-rich reduction gas,
heating the hydrogen-rich reduction gas to a predetermined temperature,
introducing the heated hydrogen-rich reduction gas into the direct reduction shaft in order to reduce the iron ore and produce sponge iron, and
extracting the produced sponge iron from the direct reduction shaft,
said method being characterized in that it comprises the steps of
measuring the flow rate of the hydrogen-rich gas, and
controlling a flow rate of iron ore into the direction reduction shaft on basis of the measured flow rate of the hydrogen-rich gas and
controlling a flow rate of the sponge iron extracted out of the direct reduction shaft on basis of the measured flow rate of the hydrogen-rich gas, wherein
the flow rate of the iron ore and the flow rate of the sponge iron are controlled such that they are proportional to the measured flow rate of the hydrogen-rich reduction gas.

According to one embodiment, the method comprises the further step of measuring the composition of the hydrogen-rich reduction gas, wherein the flow rate of the iron ore into the shaft and the flow rate of the sponge iron extracted out of the direct reduction shaft are controlled on basis of the measured flow rate of the hydrogen-rich reduction gas and on basis of the measured composition of the hydrogen-rich reduction gas.

According to one embodiment, the composition of the hydrogen-rich reduction gas is evaluated with regard to its content of reduction means that will result in the direct reduction of the iron ore, wherein the content of reduction means and the flow rate of the hydrogen-rich reduction gas are multiplied with each other for the generation of an input value on basis of which the flow rates of the iron ore and the sponge iron are controlled.

According to one embodiment, the flow rate of the iron ore and the flow rate of the sponge iron are controlled such that they correspond to each other and such that the combined level of iron ore and sponge iron in the direct reduction shaft is maintained at a constant level.

According to one embodiment, the flow rate of the hydrogen-rich reduction gas has a predetermined nominal value applied during a predetermined nominal operation condition of the direct reduction shaft, and wherein a predetermined initial decrease of the flow rate of the hydrogen-rich gas from said nominal value down to a threshold value is compensated by addition of methane gas to the hydrogen rich gas, without corresponding decrease of the flow rate of iron ore and sponge iron, and the flow rate of the iron ore and the flow rate of the sponge iron are controlled on basis of the measured flow rate of the hydrogen gas when the flow rate of the hydrogen-rich gas decreases further below said threshold value.

According to one embodiment, the method comprises the step of measuring a pressure in the direct reduction shaft, wherein the addition of said methane gas is controlled such that a nominal operation pressure is maintained in the direct reduction shaft upon decrease of the flow rate of hydrogen-rich reduction gas from said nominal value to said threshold value.

According to one embodiment, the hydrogen-rich gas comprises at least 80 wt. % hydrogen gas.

According to one embodiment, the hydrogen-rich gas comprises at least 90 wt. % hydrogen gas.

According to one embodiment, the hydrogen-rich gas comprises at least 95 wt. % hydrogen gas.

According to one embodiment, the hydrogen-rich reduction gas is comprised by hydrogen gas produced in an electrolyser and hydrogen gas obtained from off-gas extracted from the direction reduction shaft.

According to one embodiment, the step of measuring the flow rate of the hydrogen-rich gas comprises measuring the flow rate of the hydrogen carried by the off-gas or measuring the flow rate of the hydrogen gas obtained from the off-gas. Preferably, the method comprises the step of mixing the hydrogen gas from the electrolyser with the hydrogen gas obtained from the off-gas, wherein the measurement is performed upstream a point where said hydrogen gases are mixed, as seen in a flow direction of the respective hydrogen gas. The flow rate of the hydrogen gas in the off-gas is a good indicator of whether the reduction has been performed with sufficient amount of hydrogen gas to result in sponge iron with a predetermined minimum level of metallization, preferably above 90 wt. %, or, even more preferred, above 92.5 wt. % iron. By controlling the flow rate of iron ore into the direct reduction shaft on basis of the measured flow rate of the hydrogen gas in the off-gas or obtained from the off-gas and controlling the flow rate of the sponge iron extracted out of the direct reduction shaft on basis of the measured flow rate of the hydrogen gas in the off-gas or obtained from the off-gas, the flow rate of the hydrogen carried by the off-gas can be controlled to be within a predetermined range that results in sponge iron having at least said pre-determined minimum metallization level. The object of the invention is also achieved by means of an arrangement for producing sponge iron, comprising:
a direct reduction shaft,
a device for charging iron ore into the direct reduction shaft,
a device for extracting sponge iron from the direction reduction shaft,
a hydrogen-rich reduction gas source,
a reduction gas line extending from the hydrogen-rich reduction gas source to the direct reduction shaft,
a heater for heating the hydrogen-rich reduction gas in the reduction gas line, said arrangement being characterized in that it comprises
a flow rate meter configured to measure the flow rate of the hydrogen-rich reduction gas in the reduction gas line, and
a control unit configured to control the device for charging iron ore into the direct reduction shaft and to control the device for extracting sponge iron from the direct reduction shaft on basis of input from the flow rate meter, such that the flow rate of the iron ore and the flow rate of the sponge iron are proportional to the measured flow rate of the hydrogen-rich reduction gas.

According to one embodiment, the arrangement comprises a sensor for measuring the composition of the hydrogen-rich reduction gas, and wherein the control unit is configured control the device for charging iron ore into the direct reduction shaft and to control the device for extracting sponge iron from the direct reduction shaft on basis of input from said sensor.

According to one embodiment, the control unit is configured to evaluate the composition of the hydrogen-rich reduction gas with regard to its content of reduction means that will result in the direct reduction of the iron ore, and to multiply the content of reduction means and the flow rate of the hydrogen-rich reduction gas with each other and to generate an input value on basis of which the device for charging iron ore and the device for extracting sponge iron are controlled.

According to one embodiment, the control unit is configured to the device for charging iron ore into the direct reduction shaft and to control the device for extracting sponge iron from the direct reduction shaft such that flows of iron ore and sponge iron correspond to each other and such that the combined level of iron ore and sponge iron in the direct reduction shaft is maintained at a constant level.

According to one embodiment, the arrangement comprises a methane gas source and a device for controlling a flow of methane gas from said methane gas source into the reduction gas line, and wherein the flow rate of the hydrogen-rich reduction gas has a predetermined nominal value applied during a predetermined nominal operation condition of the direct reduction shaft, and wherein, as a response to a measured predetermined initial decrease of the flow rate of the hydrogen-rich gas from said nominal value down to a threshold value, the control unit is configured to compensate for said decrease by controlling an addition of methane gas from the methane gas source to the hydrogen-rich reduction gas, without corresponding decrease of the flow rate of iron ore and sponge iron, and wherein control unit is configured to control the flow rate of the iron ore and the flow rate of the sponge iron by controlling the device for charging iron ore and the device for extracting sponge iron on basis of the measured flow rate of the hydrogen-rich reduction gas when the flow rate of the hydrogen-rich reduction gas decreases further below said threshold value.

According to one embodiment, the arrangement comprises a sensor for measuring a pressure in the direct reduction shaft, and wherein the control unit is configured to control the addition of said methane gas by such that a nominal operation pressure is maintained in the direct reduction shaft upon decrease of the flow rate of hydrogen-rich reduction gas from said nominal value to said threshold value.

According to one embodiment, the hydrogen-rich reduction gas source comprises an electrolyser and an off-gas return line for returning off-gas extracted from the direction reduction shaft.

According to some embodiments, the arrangement further comprises a flow rate meter configured to measure the flow rate of the hydrogen gas in the off-gas return line, wherein the control unit is configured to control the device for charging iron ore into the direct reduction shaft and to control the device for extracting sponge iron from the direct reduction shaft on basis of input from the flow rate meter. The control unit is configured to control said devices such that the flow rate of the iron ore and the flow rate of the sponge iron are proportional to the measured flow rate of the flow rate of hydrogen carried by the off-gas. In the disclosed embodiment, the flow meter is positioned upstream an off-gas cleaning arrangement provided in the off-gas return line. However, provided that the efficiency of the off-gas cleaning arrangement in terms of what percentage of the hydrogen gas it is able of withdrawing, the flow rate meter may as well be located downstream the off-gas cleaning arrangement. The control is made with regard to previous data regarding relationship between sponge iron quality, mostly defined by the metallization degree, and the hydrogen gas content in the off-gas.

### BRIEF DESCRIPTION OF THE DRAWINGS

FIG. 1 is a schematic representation of an arrangement according to an embodiment of the present invention, on which the method according to the invention is applied, and

FIG. 2 shows a second embodiment of the invention.

### DETAILED DESCRIPTION

In the following detailed description, embodiments of the method of the invention will be disclosed, as well an arrangement configured to carry out the method.

The arrangement for producing sponge iron comprises: a direct reduction shaft 1, a device 2 for charging iron ore into the direct reduction shaft 1, a device 3 for extracting sponge iron from the direction reduction shaft 1, a hydrogen-rich reduction gas source 4, 13, a reduction gas line 5 extending from the hydrogen-rich reduction gas source 4, 13 to the direct reduction shaft 1. The hydrogen-rich gas comprises at least 95 wt. % hydrogen gas. There is also provided a heater 6 for heating the hydrogen-rich reduction gas in the reduction gas line 5. According to one embodiment the heater 6 is an electric heater using electric resistance elements for heating the gas passing through the heater. The direct reduction shaft 1 is a vertical shaft in which the iron ore is charged through an inlet at the top of the shaft and extracted through a bottom of the shaft. The device 2 for charging the iron ore comprises a valve device suitable for the purpose, and the device 3 for extracting the sponge iron comprises a valve device suitable for that purpose. The hydrogen-rich reduction gas source comprises an electrolyser 4 and an off-gas return line 13 for returning off-gas extracted from the direction reduction shaft 1. The heater 6 is a heater for heating the reduction gas to a temperature in the range of 750-1 100° C.

The arrangement further comprises a flow rate meter 7 configured to measure the flow rate of the hydrogen-rich reduction gas in the reduction gas line 5, and a control unit 8 configured to control the device 2 for charging iron ore into the direct reduction shaft 1 and to control the device 3 for extracting sponge iron from the direct reduction shaft 1 on basis of input from the flow rate meter 7. The control unit 8 is configured to control said devices 2, 3 such that the flow rate of the iron ore and the flow rate of the sponge iron are proportional to the measured flow rate of the hydrogen-rich reduction gas. The control unit 8 may be any suitable combination of hardware and software by means of which the operation of the arrangement is controlled.

The arrangement further comprises a sensor 9 for measuring the composition of the hydrogen-rich reduction gas. The control unit 8 is configured control the device 2 for charging iron ore into the direct reduction shaft 1 and to control the device 3 for extracting sponge iron from the direct reduction shaft 1 on basis of input from said sensor 9. More precisely the control unit 8 is configured to evaluate the measured composition of the hydrogen-rich reduction gas with regard to its content of reduction means that will result in the direct reduction of the iron ore, and to multiply the content of reduction means and the flow rate of the hydrogen-rich reduction gas with each other and to generate an input value on basis of which the device 2 for charging iron ore and the device 3 for extracting sponge iron are controlled.

Further, the control unit 8 is configured to control the device 2 for charging iron ore and to control the device 3 for extracting sponge iron such that the flows of iron ore and sponge iron correspond to each other and such that the combined level of iron ore and sponge iron in the direct reduction shaft 1 is maintained at a constant level.

The arrangement comprises a methane gas source 10 and a valve device 11 for controlling a flow of methane gas from said methane gas source 10 into the reduction gas line 5. The flow rate of the hydrogen-rich reduction gas has a predetermined nominal value applied during a predetermined nominal operation condition of the direct reduction shaft 1, and, as a response to a measured predetermined initial decrease of the flow rate of the hydrogen-rich gas from said nominal value down to a threshold value, the control unit 8 is configured to compensate for said decrease by controlling an addition of methane gas from the methane gas source to the hydrogen-rich reduction gas, without corresponding decrease of the flow rate of iron ore and sponge iron. The control unit 8 is configured to control the flow rate of the iron ore and the flow rate of the sponge iron by controlling the device 2 for charging iron ore and the device 3 for extracting sponge iron on basis of the measured flow rate of the hydrogen-rich reduction gas when the flow rate of the hydrogen-rich reduction gas decreases further below said threshold value.

The arrangement further comprises a sensor 12 for measuring a pressure in the direct reduction shaft 1. The output from the pressure sensor 12 is used as input to the control unit 8. The control unit 8 is configured to control the addition of said methane gas such that a nominal operation pressure is maintained in the direct reduction shaft 1 upon decrease of the flow rate of hydrogen-rich reduction gas from said nominal value to said threshold value.

Needless to say, the arrangement is also provided with further equipment well known to the person skilled in the art for achieving functions such as pressurization, cleaning of off-gas etc. The arrangement thus also comprises an off-gas cleaning arrangement 14 off-gas return line 13 and a compressor arrangement 15 provided in the reduction gas line 5. There may also be further compressors and cleaning steps provided for, if found necessary.

The arrangement is thus configured so as to perform the method of the invention. The method comprises the following steps:
charging iron ore into a direct reduction shaft 1,
providing a hydrogen-rich reduction gas,
heating the hydrogen-rich reduction gas to a predetermined temperature,
introducing the heated hydrogen-rich reduction gas into the direct reduction shaft 1 in order to reduce the iron ore and produce sponge iron, and
extracting the produced sponge iron from the direct reduction shaft 1.

The method further comprises the steps of:
measuring the flow rate of the hydrogen-rich gas, and
controlling a flow rate of iron ore into the direction reduction shaft 1 on basis of the measured flow rate of the hydrogen-rich gas and
controlling a flow rate of the sponge iron extracted out of the direct reduction shaft 1 on basis of the measured flow rate of the hydrogen-rich gas, wherein
the flow rate of the iron ore and the flow rate of the sponge iron are controlled such that they are proportional to the measured flow rate of the hydrogen-rich reduction gas.

The method also comprises the step of measuring the composition of the hydrogen-rich reduction gas, wherein the flow rate of the iron ore into the shaft 1 and the flow rate of the sponge iron extracted out of the direct reduction shaft 1 are controlled on basis of the measured flow rate of the hydrogen-rich reduction gas and on basis of the measured composition of the hydrogen-rich reduction gas.

The composition of the hydrogen-rich reduction gas is evaluated with regard to its content of reduction means that will result in the direct reduction of the iron ore, and the content of reduction means and the flow rate of the hydrogen-rich reduction gas are multiplied with each other for the generation of an input value on basis of which the flow rates of the iron ore and the sponge iron are controlled.

The flow rate of the iron ore and the flow rate of the sponge iron are controlled such that they correspond to each other and such that the combined level of iron ore and sponge iron in the direct reduction shaft 1 is maintained at a constant level.

The flow rate of the hydrogen-rich reduction gas has a predetermined nominal value applied during a predetermined nominal operation condition of the direct reduction shaft 1 and wherein a predetermined initial decrease of the flow rate of the hydrogen-rich gas from said nominal value down to a threshold value is compensated by addition of methane gas to the hydrogen rich gas, without corresponding decrease of the flow rate of iron ore and sponge iron, and wherein the flow rate of the iron ore and the flow rate of the sponge iron are controlled on basis of the measured flow rate of the hydrogen gas when the flow rate of the hydrogen-rich gas decreases further below said threshold value. The addition of methane gas is an optional embodiment. As alternative embodiment, compensation of the fluctuation of the flow of the hydrogen rich reduction gas is only done by means of controlling the flow rate of the iron ore into the shaft and the flow rate of the sponge iron out of the shaft.

The method further comprises the step of measuring a pressure in the direct reduction shaft 1, wherein the addition of said methane gas is controlled such that a nominal operation pressure is maintained in the direct reduction shaft 1 upon decrease of the flow rate of hydrogen-rich reduction gas from said nominal value to said threshold value.

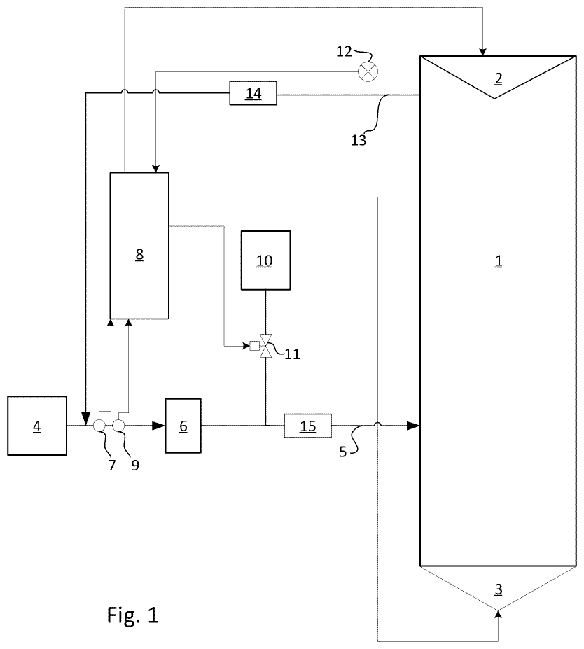

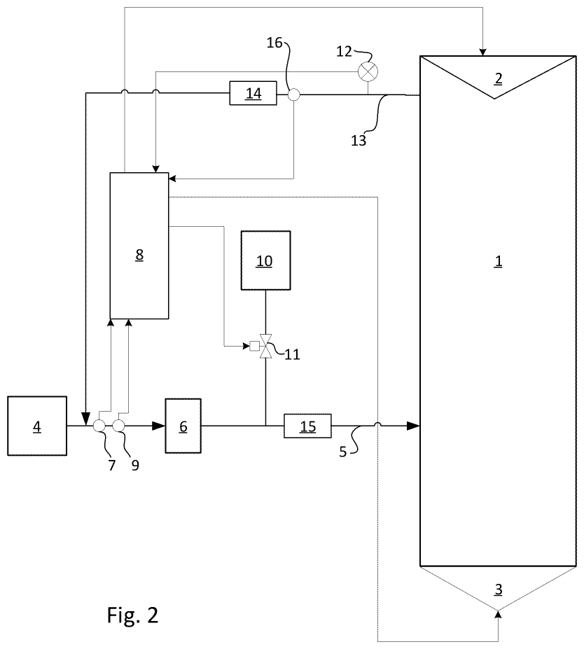

The second embodiment disclosed in FIG. 2 differs from the embodiment shown in FIG. 1 in that the step of measuring the flow rate of the hydrogen-rich gas comprises measuring the flow rate of the hydrogen carried by the off-gas or measuring the flow rate of the hydrogen gas obtained from the off-gas. Preferably, the method comprises the step of mixing the hydrogen gas from the electrolyser with the hydrogen gas obtained from the off-gas, wherein the measurement is performed upstream a point where said hydrogen gases are mixed, as seen in a flow direction of the respective hydrogen gas. The flow rate of the hydrogen gas in the off-gas is a good indicator of whether the reduction has been performed with sufficient amount of hydrogen gas to result in sponge iron with a predetermined minimum level of metallization, preferably above 90 wt. %, or, even more preferred, above 92.5 wt. % iron. By controlling the flow rate of iron ore into the direct reduction shaft on basis of the measured flow rate of the hydrogen gas in the off-gas or obtained from the off-gas and controlling the flow rate of the sponge iron extracted out of the direct reduction shaft on basis of the measured flow rate of the hydrogen gas in the off-gas or obtained from the off-gas, the flow rate of the hydrogen carried by the off-gas can be controlled to be within a predetermined range that results in sponge iron having at least said pre-determined minimum metallization level.

The arrangement according to FIG. 2 comprises a flow rate meter 16 configured to measure the flow rate of the hydrogen gas in the off-gas return line 13, wherein the control unit 8 is configured to control the device 2 for charging iron ore into the direct reduction shaft 1 and to control the device 3 for extracting sponge iron from the direct reduction shaft 1 on basis of input from the flow rate meter 16. The control unit 8 is configured to control said devices 2, 3 such that the flow rate of the iron ore and the flow rate of the sponge iron are proportional to the measured flow rate of the flow rate of hydrogen carried by the off-gas. In the disclosed embodiment, the flow meter 16 is positioned upstream the off-gas cleaning arrangement 14. However, provided that the efficiency of the off-gas cleaning arrangement 14 in terms of what percentage of the hydrogen gas it is able of withdrawing, the flow rate meter 16 may as well be located downstream the off-gas cleaning arrangement 14.

The control unit 8 is preferably configured so as to prioritize the input from the flow rate meter 16 in the off-gas return line visavi the input from the flow rate meter 7 in the reduction gas line 5. Accordingly, the input from the flow meter in the off-gas return line 13 will be decisive for the control of said devices 2, 3 such that the flow rate of the iron ore and the flow rate of the sponge iron are proportional to the measured flow rate of the flow rate of hydrogen carried by the off-gas in case the input from the different meters result in different suggestions of the output from the control unit 8.

1. A method for a continuous production of sponge iron from iron ore, comprising the steps of:
charging iron ore into a direct reduction shaft,
providing a hydrogen-rich reduction gas,
heating the hydrogen-rich reduction gas to a predetermined temperature,
introducing the heated hydrogen-rich reduction gas into the direct reduction shaft in order to reduce the iron ore and produce sponge iron, and
extracting the produced sponge iron from the direct reduction shaft,
wherein said method further comprises the steps of:
measuring the flow rate of the hydrogen-rich gas,
controlling a flow rate of iron ore into the direct reduction shaft based on the measured flow rate of the hydrogen-rich gas, and
controlling a flow rate of the sponge iron extracted out of the direct reduction shaft based on basis of the measured flow rate of the hydrogen-rich gas,
wherein the flow rate of the iron ore and the flow rate of the sponge iron are controlled such that they are proportional to the measured flow rate of the hydrogen-rich reduction gas.

2. The method according to claim 1, comprising the further step of measuring the composition of the hydrogen-rich reduction gas, wherein the flow rate of the iron ore into the shaft and the flow rate of the sponge iron extracted out of the direct reduction shaft are controlled on basis of the measured flow rate of the hydrogen-rich reduction gas and on basis of the measured composition of the hydrogen-rich reduction gas.

3. The method according to claim 2, wherein the composition of the hydrogen-rich reduction gas is evaluated with regard to its content of reduction means that will result in the direct reduction of the iron ore, and wherein the content of reduction means and the flow rate of the hydrogen-rich reduction gas are multiplied with each other for the generation of an input value on basis of which the flow rates of the iron ore and the sponge iron are controlled.

4. The method according to claim 1, wherein the flow rate of the iron ore and the flow rate of the sponge iron are controlled such that they correspond to each other and such that the combined level of iron ore and sponge iron in the direct reduction shaft (1) is maintained at a constant level.

5. The method according to claim 1, wherein the flow rate of the hydrogen-rich reduction gas has a predetermined nominal value applied during a predetermined nominal operation condition of the direct reduction shaft, and wherein a predetermined initial decrease of the flow rate of the hydrogen-rich gas from said nominal value down to a threshold value is compensated by addition of methane gas to the hydrogen rich gas, without corresponding decrease of the flow rate of iron ore and sponge iron, and wherein the flow rate of the iron ore and the flow rate of the sponge iron are controlled on basis of the measured flow rate of the hydrogen gas when the flow rate of the hydrogen-rich gas decreases further below said threshold value.

6. The method according to claim 5, comprising the step of measuring a pressure in the direct reduction shaft, wherein the addition of said methane gas is controlled such that a nominal operation pressure is maintained in the direct reduction shaft upon decrease of the flow rate of hydrogen-rich reduction gas from said nominal value to said threshold value.

7. The method according to claim 1, wherein the hydrogen-rich gas comprises at least 80 wt. % hydrogen gas.

8. The method according to claim Z, wherein the hydrogen-rich gas comprises at least 90 wt. % hydrogen gas.

9. The method according to claim 8, wherein the hydrogen-rich gas comprises at least 95 wt. % hydrogen gas.

10. The method according to claim 1, wherein the hydrogen-rich reduction gas is comprised by hydrogen gas produced in an electrolyser and hydrogen gas obtained from off-gas extracted from the direct reduction shaft.

11. The method according to claim 10, wherein the step of measuring the flow rate of the hydrogen-rich gas comprises measuring the flow rate of the hydrogen carried by the off-gas or measuring the flow rate of the hydrogen gas obtained from the off-gas.

12. An arrangement for producing sponge iron, comprising:
a direct reduction shaft, a device for charging iron ore into the direct reduction shaft,
a device for extracting sponge iron from the direct reduction shaft,
a hydrogen-rich reduction gas source,
a reduction gas line extending from the hydrogen-rich reduction gas source to the direct reduction shaft,
a heater for heating the hydrogen-rich reduction gas in the reduction gas line,
a flow rate meter configured to measure the flow rate of the hydrogen-rich reduction gas in the reduction gas line, and
a control unit configured to control the device for charging iron ore into the direct reduction shaft and to control the device for extracting sponge iron from the direct reduction shaft based on input from the flow rate meter, such that the flow rate of the iron ore and the flow rate of the sponge iron are proportional to the measured flow rate of the hydrogen-rich reduction gas.

13. The arrangement according to claim 12, wherein the further comprising a sensor for measuring the composition of the hydrogen-rich reduction gas, and wherein the control unit is configured control the device for charging iron ore into the direct reduction shaft and to control the device for extracting sponge iron from the direct reduction shaft based on basis of input from said sensor.

14. The arrangement according claim 13, wherein the control unit is configured to evaluate the composition of the hydrogen-rich reduction gas with regard to its content of reduction means that will result in the direct reduction of the iron ore, and to multiply the content of reduction means and the flow rate of the hydrogen-rich reduction gas with each other and to generate an input value based on basis of which the device for charging iron ore and the device for extracting sponge iron are controlled.

15. The arrangement according to 12, wherein the control unit is configured to control the device for charging iron ore into the direct reduction shaft and to control the device for extracting sponge iron from the direct reduction shaft such that flows of iron ore and sponge iron correspond to each other and such that the combined level of iron ore and sponge iron in the direct reduction shaft is maintained at a constant level.

16. The arrangement according to claim 12, wherein the arrangement comprises a methane gas source and a valve device for controlling a flow of methane gas from said methane gas source into the reduction gas line, and wherein the flow rate of the hydrogen-rich reduction gas has a predetermined nominal value applied during a predetermined nominal operation condition of the direct reduction shaft, and wherein, as a response to a measured predetermined initial decrease of the flow rate of the hydrogen-rich gas from said nominal value down to a threshold value, the control unit is configured to compensate for said decrease by controlling an addition of methane gas from the methane gas source to the hydrogen-rich reduction gas, without corresponding decrease of the flow rate of iron ore and sponge iron, and wherein control unit configured to control the flow rate of the iron ore and the flow rate of the sponge iron by controlling the device for charging iron ore and the device for extracting sponge iron on basis of the measured flow rate of the hydrogen-rich reduction gas when the flow rate of the hydrogen-rich reduction gas decreases further below said threshold value.

17. The arrangement according to claim 16, wherein the arrangement comprises a sensor for measuring a pressure in the direct reduction shaft, and wherein the control unit is configured to control the addition of said methane gas such that a nominal operation pressure is maintained in the direct reduction shaft upon decrease of the flow rate of hydrogen-rich reduction gas from said nominal value to said threshold value.

18. The arrangement according to claim 12, wherein the hydrogen-rich reduction gas source comprises an electrolyser and an off-gas return line for returning off-gas extracted from the direction reduction shaft.

19. The arrangement according to claim 18, further comprising a flow rate meter configured to measure the flow rate of the hydrogen gas in the off-gas return line, wherein the control unit is configured to control the device for charging iron ore into the direct reduction shaft and to control the device for extracting sponge iron from the direct reduction shaft based on input from the flow rate meter.
